(19) United States
(12) Patent Application Publication
(10) Pub. No.: US 2009/0300592 A1
(43) Pub. Date: Dec. 3, 2009

(54) AUTOMATED DIALOG COMPLIANCE MECHANISMS

(75) Inventor: James William Joyce, Englewood, CO (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/131,027

(22) Filed: May 30, 2008

(51) Int. Cl. G06F 9/45

(52) U.S. Cl. 717/154

(57) ABSTRACT

Tools and techniques are described for automated dialog compliance mechanisms. Systems provided by this description may include toolkits for developing and debugging software code, with this code operative to create dialog boxes within a user interface. These systems may also include automated dialog compliance mechanisms for receiving requests from the toolkits to evaluate the code against guidelines specified across an enterprise and applicable to constructing the dialog boxes.

### BACKGROUND

Software vendors may define or establish guidelines applicable to user interface (UI) elements, including but not limited to, dialog boxes, forms, windows, or other UI elements that provide information to users, or enable users to interact with software. Software developers or programmers may or may not adhere to or be aware of these guidelines, so maintaining compliance with these guidelines is an ongoing challenge for many vendors. In previous techniques, compliance may be achieved by manually and visually reviewing the UI elements. However, such manual reviews may quickly become tedious and error-prone.

### SUMMARY

Tools and techniques are described for automated dialog compliance mechanisms. Systems provided by this description may include toolkits for developing and debugging software code, with this code operative to create dialog boxes within a user interface. These systems may also include automated dialog compliance mechanisms for receiving requests from the toolkits to evaluate the code against guidelines specified across an enterprise and applicable to constructing the dialog boxes.

The above-described subject matter may also be implemented as a method, computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating systems or operating environments for automated dialog compliance mechanisms.

FIG. 2 is a block diagram illustrating systems or operating environments for automated dialog compliance mechanisms, operating within a client/server model.

FIG. 3 is a flow diagram illustrating processes for performing automated dialog compliance mechanisms.

### DETAILED DESCRIPTION

The following detailed description is directed to technologies for automated dialog compliance mechanisms. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of tools and techniques for automated dialog compliance mechanisms will be described.

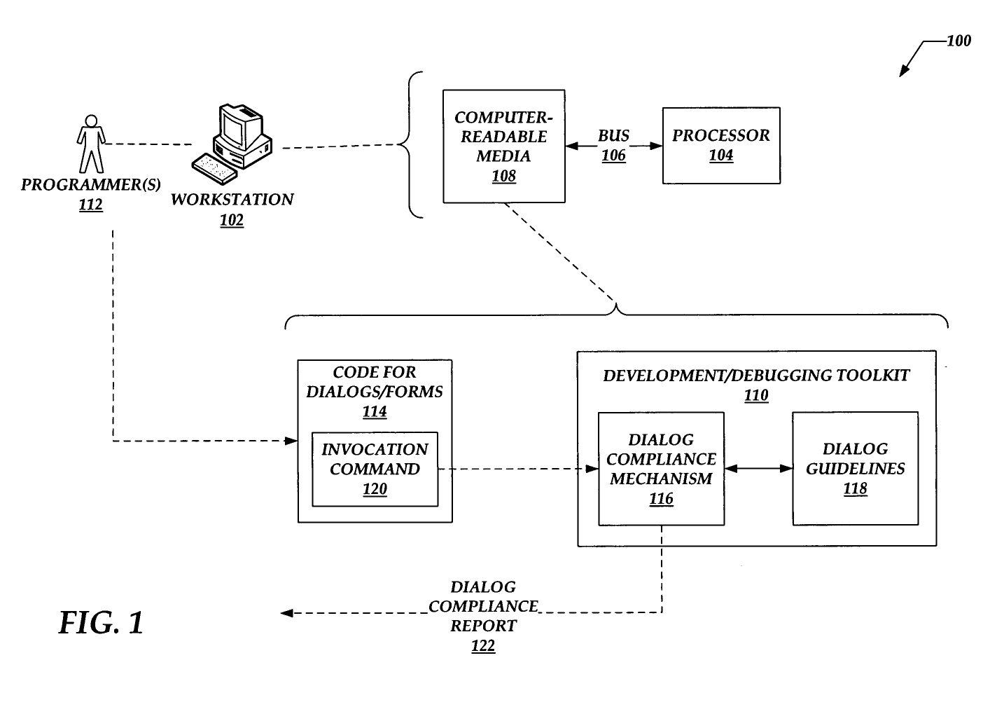

FIG. 1 illustrates systems or operating environments, denoted generally at 100, for automated dialog compliance mechanisms. These systems 100 may include one or more workstations 102, with FIG. 1 providing one workstation for clarity of illustration only. However, implementations of the description herein may include any number of workstations.

The graphical elements used in FIG. 1 to depict the workstations 102, and other components shown herein, are chosen only to facilitate illustration, and not to limit possible implementations of this description. More particularly, FIG. 1 illustrates the workstation 102 as a desktop computing system, but the workstation could also be a mobile, notebook, or laptop computing system.

Turning to the workstation 102 in more detail, it may include one or more processors 104, which may have a particular type or architecture, chosen as appropriate for particular implementations. The processors 104 may couple to one or more bus systems 106 chosen for compatibility with the processors 104.

The workstations 102 may also include one or more instances of computer-readable storage media 108, which couple to the bus systems 106. The bus systems may enable the processors 104 to read code and/or data to/from the computer-readable storage media 108. The media 108 may represent storage elements implemented using any suitable technology, including but not limited to semiconductors, magnetic materials, optics, or the like. The media 108 may include memory components, whether classified as RAM, ROM, flash, or other types, and may also represent hard disk drives.

The storage media 108 may include one or more data structures and modules of instructions that, when loaded into the processor 104 and executed, cause the workstations 102 to perform various techniques for automated dialog compliance mechanisms. Examples of these modules may include a development/debugging toolkit 110, which may enable users or programmers 112 to interact with the workstations 102 in authoring code 114 for creating dialog boxes, forms, windows, and other user interface (UI) elements.

Turning to the toolkit 110 in more detail, it may include a set of software modules providing a dialog compliance mechanism 116, which provides automated system for evaluating whether the UI elements created by the code 114 complies with applicable dialog guidelines, which are represented generally at 118. FIG. 1 denotes data and/or process flows between the dialog compliance mechanism and the dialog guidelines by the bidirectional arrows connecting blocks 116 and 118. In some implementations, the dialog guidelines may be hardcoded into the dialog compliance mechanism.

In example implementations, these systems 100 may be deployed within an organization or enterprise that develops software. This software may contain any number of the types of UI elements described herein. In this context, the dialog guidelines 118 may be specified across such organizations or enterprises, to indicate minimum standards applicable to, for example, the layout, composition, and appearance of these UI elements. For the purposes of this description, but not to limit possible implementations, the following examples of dialog guidelines are given:
a maximum size specified for the dialogs;
whether an icon is shown in a title bar of the dialog;
whether buttons operative to minimize or maximize the dialog are shown or displayed in the title bar;
whether a help button is shown in the title bar;
whether or not the dialog window appears in a taskbar;
a minimum size applicable to sizable dialogs;
whether the dialogs default and cancel buttons are set;
whether the dialog complies with a standard dialog font;
whether the entire dialog fits within a predefined screen size (compliance with this guideline may involve automatically resizing controls within the dialog);
whether the dialog complies with specific property values applicable to any contained controls; and/or
in cases where the dialog contains text boxes, combination boxes, or other sub-elements, evaluating whether these sub-elements comply with maximum length parameters based on database fields with which these sub-elements may be associated.

It is noted that implementations of this description may include dialog guidelines other than those examples provided above, without departing from the scope and spirit of this description. It is also noted that different organizations may implement different dialog guidelines, as appropriate in different implementations scenarios and related circumstances.

Referring to the code 114 in more detail, the programmers 112 may invoke the dialog compliance mechanism 116 by including a predefined invocation command 120 within the code 114. When the code 114 is submitted to the toolkit 110 for building into an executable, the toolkit 110 may process the code 114, encountering the invocation command 120 in cases where this command is included within the code 114. In turn, the toolkit 110 may submit the code 114 to the dialog compliance mechanism 116 for processing against the dialog guidelines 118.

FIG. 1 denotes at 122 the outputs of the dialog compliance mechanism 116, after processing the code 114 against the dialog guidelines 118. These outputs 122 may take the form of a dialog compliance report, which in some cases may be provided as feedback to the programmers 112. In addition, the outputs 122 (e.g., the dialog compliance report) may be provided to testing personnel, management personnel, systems integrators, or other interested parties. In turn, the programmers or other personnel may resolve the noncompliance issues by revising the code 114 as appropriate.

In general, the dialog compliance report may contain different types of information, depending on the results of processing the code 114 against the dialog guidelines 118. In cases where the dialog compliance mechanism 116 did not detect any instances of noncompliance in the code 114, the compliance report or outputs 122 may so indicate. In cases where the dialog compliance mechanism 116 does detect instances of noncompliance in the code 114, the compliance report may highlight, flag, or otherwise indicate these instances of noncompliance, to facilitate resolution thereof.

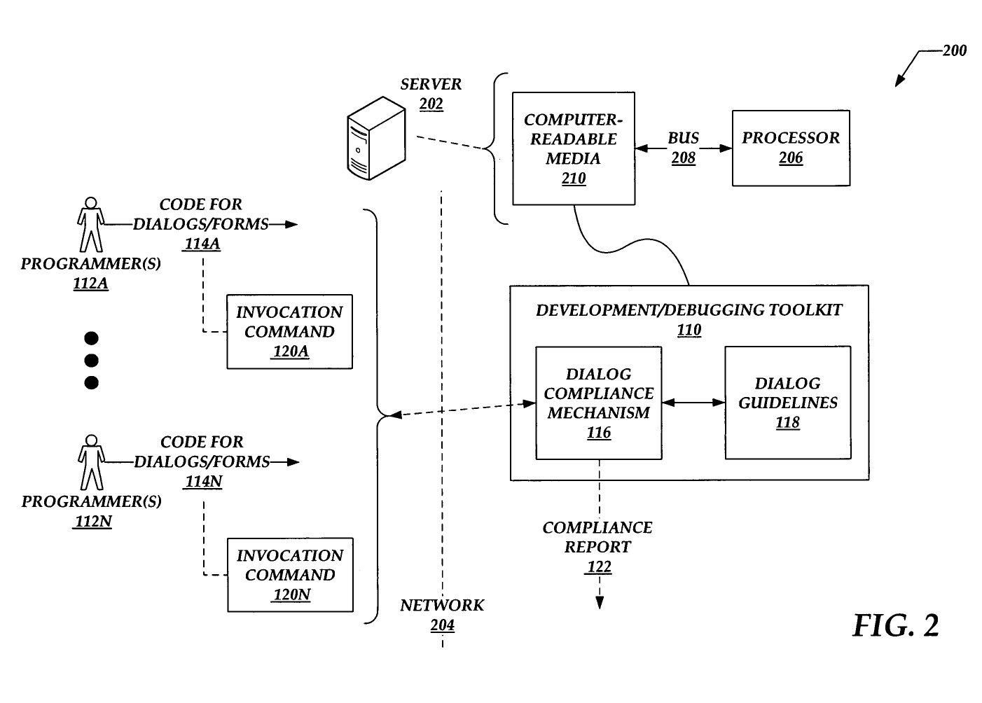

Without limiting possible implementations, these systems 100 as shown in FIG. 1 may be characterized as a “stand-alone” model or scenario. In such stand-alone scenarios, the workstation 102 may itself provide the tools and techniques for automated dialog compliance mechanisms, without significant involvement by other systems. However, the description herein may also be implemented in client/server models or scenarios, as now described with FIG. 2.

FIG. 2 illustrates systems or operating environments, denoted generally at 200, for automated dialog compliance mechanisms, operating within a client/server model. For convenience of description, but not to limit possible implementations, FIG. 2 may carry forward some elements from previous drawings, and denote them with identical reference numbers. For example, FIG. 2 carries forward examples of programmers at 112a and 112n, who may respectively author code for dialogs/forms, as denoted at 114a and 114n. Although FIG. 2 illustrates two examples of the programmers, it is noted that the client/server model may support or accommodate any number of programmers 112.

In turn, the code instances 114a and 114n may include respective invocation commands 120a and 120n, which are operative to invoke the dialog compliance mechanism 116 to process the respective code 114a and 114n for compliance with the dialog guidelines 118. The dialog compliance mechanism 116 may produce a compliance report, such as the compliance report 122, which may indicate any instances of noncompliance occurring within the code 114a and/or 114n. FIG. 1 carries forward an example development/debugging toolkit at 110, which may incorporate the dialog compliance mechanism 116 and representations of the dialog guidelines 118.

The programmers 112a and 112n may interact with one or more server systems 202 over one or more intermediate networks 204. These networks 204 generally represent any protocols, adapters, components, and other general infrastructure associated with wired and/or wireless communications networks. Such networks 204 may be global, regional, local, and/or personal in scope and nature, as appropriate in different implementations. the programmers 112a and 112n may each operate respective workstations (e.g., 102 in FIG. 1, but not carried forward into FIG. 2 to promote clarity), which may communicate with the server systems 202 using appropriate protocols and techniques.

Turning to the server systems 202 in more detail, these systems may include one or more processors 206, which may have a particular type or architecture, chosen as appropriate for particular implementations. However, the processors 206 may or may not have the same type and architecture as the processors 104 shown in FIG. 1. The processors 206 may couple to one or more bus systems 208 chosen for compatibility with the processors 206.

The server systems 202 may also include one or more instances of computer-readable storage media 210, which couple to the bus systems 208. The bus systems may enable the processors 206 to read code and/or data to/from the computer-readable storage media 210. The media 210 may represent storage elements implemented using any suitable technology, including but not limited to semiconductors, magnetic materials, optics, or the like. The media 210 may include memory components, whether classified as RAM, ROM, flash, or other types, and may also represent hard disk drives.

The storage media 210 may include one or more data structures and modules of instructions that, when loaded into the processor 206 and executed, cause the server systems 202 to perform various techniques for automated dialog compliance mechanisms. Examples of these modules may include the development/debugging toolkit 110, which in turn may include the dialog compliance mechanism 116 and the dialog guidelines 118.

In some scenarios, a given developer may write code that implements the dialog guidelines in a suitable programming language (e.g., C# or the like), and then build a software product that incorporates the dialog guidelines. Any subsequent changes to the guidelines may involve updating the code and rebuilding the product. Some standalone scenarios may operate under a single set of rules. However, in other scenarios, the dialog guidelines may be updated on the fly without rebuilding the product. In addition, server systems 202 operating under the client/server model may provide hosted dialog compliance services to or on behalf of a plurality of different workstations (e.g., 102 shown in FIG. 1), with the different workstations operating in different enterprise environments. For example, some workstations may operate within a first enterprise, subject to a first set of dialog guidelines, while other workstations may operate within another enterprise, subject to another set of dialog guidelines. These server systems 202 may receive and maintain instances of the dialog guidelines 118 as specified by different enterprise environments.

Whether operating in a stand-alone model, in a client/server model, or in a hosted services model, the dialog compliance mechanism 116 may establish and publish a set of application program interfaces (APIs) that specify various parameters related to invoking the dialog compliance mechanism. For example, these APIs may define the invocation commands (e.g., 120), as well as any methods or classes in which clients or workstations may communicate with the dialog compliance mechanism.

In some cases, the UI elements or dialog boxes as described herein may include localizable text. The toolkits 110 (or APIs associated there with) may expose user-settable flags that enable users to request that this localizable text be pseudo-localized. Typically, localizing text results in the text expanding by approximately 30 to 40%. Thus, in response to the user enabling these flags, the toolkits 110 may approximate the localization of this localizable text. This approximation may include padding the localizable text with characters, expanding the localizable text by some user-specified amount (e.g., 30%-40%, or any other amount as appropriate in different circumstances). Afterwards, the toolkits 110 may submit this pseudo-localized (e.g., expanded) text to the dialog compliance mechanism 116 for evaluation. in this manner, the toolkits 110 as described herein may preliminarily check whether localizing text that is included in UI elements may cause non-compliance with applicable dialog guidelines.

In such scenarios, programmers 112a and 112n developing code 114a and 114n in these different enterprise environments may submit their respective code to the server system for analysis against the appropriate set of dialog guidelines. In turn, the toolkit 110 may invoke the dialog compliance mechanism to evaluate the code 114a and 114n against the appropriate setup dialog guidelines, and may return compliance reports 122 accordingly.

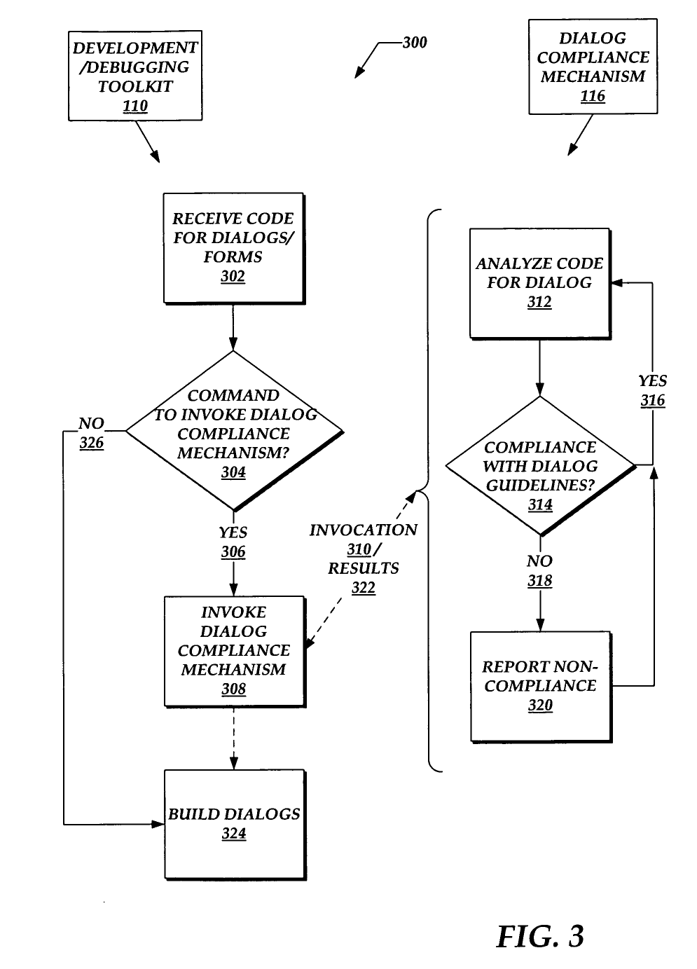

Having described the operating environments 100 and 200 in FIGS. 1 and 2, the discussion now turns to a description of process flows for automated dialog compliance mechanisms. This description is now provided with FIG. 3.

FIG. 3 illustrates process flows, denoted generally at 300, for performing automated dialog compliance mechanisms. For purposes of this description, but not to limit possible implementations, the process flows 300 are illustrated and described herein as being performed by the development/debugging toolkit 110 in cooperation with the dialog compliance mechanism 116. However, implementations of this description may perform the process flows 300 using other components without departing from the scope and spirit of this description. In addition, these process flows are described as proceeding in certain orders only for purposes of this description, and implementations of these process flows may proceed in different orders as well.

Turning to the process flows 300 in more detail, block 302 represents receiving code that defines one or more instances of dialogs, forms, windows, or other UI elements. Block 302 may include receiving code authored or maintained by programmers (e.g., 112 in FIG. 1 or 2).

Decision block 304 represents determining whether the code received in block 302 includes a command to invoke an automated dialog compliance mechanism (e.g., 116 in FIG. 1 or 2). Examples of such invocation commands are shown at 120 in FIGS. 1 and 2.

From decision block 304, if the code includes the invocation command, the process flows 300 may take Yes branch 306 to block 308, which represents invoking the dialog compliance mechanism. FIG. 3 represents this invocation at 310.

Turning to the dialog compliance mechanism 116, block 312 represents analyzing the dialog code received in block 302 against any guidelines (e.g., 118 in FIG. 1 or 2) applicable to this code. Block 312 may include analyzing the dialog code against the example guidelines provided above in the description of FIGS. 1 and 2. However, it is noted that block 312 may also include analyzing the code against other guidelines, without departing from the scope and spirit of this description.

In turn, decision block 314 represents determining whether the analyzed code complies with any applicable guidelines. If so, the process flows 300 may take Yes branch 316 back to block 312. In this manner, the process flows may repeat block 312 and 314 any number of times to analyze particular portions of a given input block of code.

From decision block 314, if block 312 identifies any instances of noncompliance with the applicable dialog guidelines, the process flows 300 may take No branch 318 to block 320. Block 320 represents reporting any instances of noncompliance with the applicable dialog guidelines.

From block 320, if additional dialog code remains to be tested, the process flows 300 may return to block 312 to continue. End-of-file or other similar tests for terminating processing within the dialog compliance mechanism 116 are omitted from FIG. 3 in the interests of conciseness.

When the dialog compliance mechanism 116 completes analyzing or processing a given block or section of code, it may return results of this analysis or processing to the toolkit 110, as represented at 322. Having received the results 322 of the compliance analysis, the toolkit 110 may determine whether to build the dialogs or forms as specified by the code received in block 302. For example, in cases where the results 322 indicate complete compliance with the applicable guidelines, then block 308 may proceed to block 324 to build these forms or dialogs.

In other scenarios, the results 322 may indicate or flag instances of noncompliance with these applicable guidelines. In such cases, block 308 may include determining whether to build the dialogs or forms despite such noncompliance. For example, block 308 may proceed to block 324 to build the forms, and graphically highlight areas of noncompliance within the forms of the benefit of, for example, responsible programmers or developers (e.g., 112 in FIGS. 1 and 2). In other examples, block 308 may notify the responsible programmers or developers indicating areas of noncompliance within a code listing, without actually building the forms in block 324. Therefore, FIG. 3 includes a dashed arrow connecting blocks 308 and 324.

Returning to decision block 304, if the code received in block 302 does not include the invocation command (e.g., 120), the process flows 300 may take No branch 326 directly to block 324, thereby bypassing block 308 and not invoking the automated compliance mechanism. In this scenario, block 324 would build the dialogs despite any instances of noncompliance within the code received in block 302.

Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

In addition, certain process and data flows are represented herein as unidirectional only for the purposes of facilitating this description. However, these unidirectional representations do not exclude or disclaim implementations that incorporate bidirectional flows.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. At least one computer-readable storage medium having computer-executable instructions stored thereon which, when executed by a computer, cause the computer to perform a method comprising:
receiving code for creating at least one dialog box within a user interface; and
determining whether the code contains at least one command to invoke an automated mechanism for evaluating compliance of the code with at least one guideline applicable to constructing the dialog box.

2. The storage medium of claim 1, further comprising instructions for invoking the automated mechanism in response to determining that the code contains at least the command.

3. The storage medium of claim 1, further comprising instructions for receiving results from the automated mechanism indicating any instances of noncompliance with the guideline occurring within the code.

4. The storage medium of claim 1, further comprising instructions for building the dialog box from the code.

5. The storage medium of claim 4, wherein the instructions for building the dialog box include instructions for highlighting within the dialog box any instances of noncompliance with the guideline.

6. The storage medium of claim 4, further comprising instructions for:
receiving a request to evaluate the code for compliance with the guideline applicable to constructing the dialog box;
analyzing the code for compliance with the guideline; and
reporting any instances within the code of noncompliance with the guideline.

7. The storage medium of claim 1, further comprising instructions for performing a preliminary localization of localizable text included within the dialog box, and for invoking the automated mechanism to evaluate preliminarily localized text for compliance with the guideline.

8. At least one computer-readable storage medium having computer-executable instructions stored thereon which, when executed by a computer, cause the computer to perform a method comprising:
receiving a request to evaluate code, for creating at least one dialog box within a user interface, for compliance with at least one guideline applicable to constructing the dialog box;
analyzing the code for compliance with the guideline;
reporting any instances within the code of noncompliance with the guideline.

9. The storage medium of claim 8, wherein the instructions for analyzing the code include instructions for determining whether the dialog box complies with a maximum size parameter applicable to the dialog box.

10. The storage medium of claim 8, wherein the instructions for analyzing the code include instructions for determining whether the dialog box complies with a guideline applicable to showing an icon within the dialog box.

11. The storage medium of claim 8, wherein the instructions for analyzing the code include instructions for determining whether the dialog box complies with a guideline applicable to displaying buttons for minimizing or maximizing the dialog box.

12. The storage medium of claim 8, wherein the instructions for analyzing the code include instructions for determining whether the dialog box complies with a guideline applicable to displaying a help button within the dialog box.

13. The storage medium of claim 8, wherein the instructions for analyzing the code include instructions for determining whether the dialog box complies with a guideline specifying a minimum size for a size-adjustable dialog box.

14. The storage medium of claim 8, wherein the instructions for analyzing the code include instructions for determining whether the dialog box complies with a guideline specifying a standard font to be used for the dialog box.

15. The storage medium of claim 8, wherein the instructions for analyzing the code include instructions for determining whether the dialog box complies with a guideline specifying dimensions applicable to text elements appearing within the dialog box.

16. The storage medium of claim 8, wherein the instructions for analyzing the code include instructions for determining whether the dialog box fits entirely within a display.

17. A system comprising:
a toolkit for developing and debugging software code, wherein the code is operative to create at least one dialog box within a user interface; and
an automated dialog compliance mechanism, operative to receive at least one request from the toolkit to evaluate the code against guidelines specified across an enterprise and applicable to constructing the dialog box.

18. The system of claim 18, as incorporated into a stand-alone workstation.

19. The system of claim 18, as incorporated into a server system coupled to communicate with a plurality of workstations.

20. The system of claim 19, wherein the server system operates a hosted dialog compliance service on behalf of a plurality of client enterprises operating the workstations, wherein the hosted dialog compliance service is operative to receive instances of code from the workstations, to evaluate the code against respective guidelines applicable to the client enterprises, and to report instances of noncompliance within the code to the client enterprises.
